(19) United States
(12) Patent Application Publication
(10) Pub. No.: US 2011/0059702 A1
(43) Pub. Date: Mar. 10, 2011

(54) METHOD, APPARATUS AND COMPUTER PROGRAM PRODUCT FOR PROVIDING A FIREWALL FOR A SOFTWARE DEFINED MULTIRADIO

(75) Inventors: Kalle August Raiskila, Nukari (FI); Tommi Juhani Zetterman, Espoo (FI); Antti-Veikko Sakari Piipponen, Tampere (FI)

(73) Assignee: Nokia Corporation, Espoo (FI)

(21) Appl. No.: 12/937,242

(22) PCT Filed: Apr. 8, 2008
(86) PCT No.: PCT/IB2008/051337

§ 371 Date: Nov. 9, 2010

(51) Int. Cl. H04B 1/00

(52) U.S. Cl. 455/69

(57) ABSTRACT

An apparatus for providing management of radio operation in a multiradio environment may include a processor. The processor may be configured to receive a communication in accordance with a protocol associated with a particular radio access technology in which the communication is associated with accessing a hardware resource for radio communication, determine whether the received communication complies with instructions defining parameters associated with providing shared access to hardware resources among a plurality of protocols associated with respective different radio access technologies, and respond to the received communication based on a result of the determining.

### TECHNOLOGICAL FIELD

Embodiments of the present invention relate generally to software defined radio (SDR) and, more particularly, relate to an apparatus, method and a computer program product for enabling the provision of a firewall for a software defined multiradio.

### BACKGROUND

A Software Defined Radio (SDR) system may be thought of as a radio communication system in which components that would traditionally have been embodied in hardware may instead be implemented using software. Thus, for example, components such as mixers, filters, amplifiers, modulators/demodulators, detectors. etc., may be embodied in software instead of by having corresponding hardware devices. However, SDR currently still requires at least some hardware components. As such, there is a current drive to push software as close to the antenna as possible to achieve a more ideal SDR.

In some embodiments, an SDR may include a computing device such as a computer (PC) having a sound card or other analog-to-digital converting device in communication with a radio frequency (RF) front end. As such, in an SDR, signal processing may be handled by the processor of the PC rather than being handled by hardware designated for such processing. Accordingly, an SDR may be enabled to receive and/or transmit according to different radio communication protocols merely by employing corresponding different software. Thus, a radio could be configured for use in accordance with one protocol while operating according to another.

Given the flexibility that may be afforded by an SDR, various communication devices such as, for example, cellular phones, may benefit from employing an SDR. Thus, for example, different radio protocols such as wideband code division multiple access (WCDMA), wireless local area network (WLAN), global positioning system (GPS) and others may be defined in software packages that may be independent of any particular radio hardware implementation. This feature may allow software packages to be loaded into a particular modem at run-time and/or may allow concurrent operation of different radio protocols. The SDR framework may also enable a particular SDR platform to be opened up to third party software or radio protocol implementations.

It is typical for radio transceivers to receive government regulator approval before operation in the radio spectrum. Testing for such approval is typically done one radio at a time. As such, operational testing typically only checks for correct radio operation against spectral usage requirements with one radio operational at any given time. Thus, for example, if a software bug associated with a particular SDR system were not initially detected, the bug may cause an erroneous radio receiver or transmitter to interfere with other radios. Furthermore, if physical resources are shared between different radio protocol stacks in which one protocol may be behaving improperly (e.g., due to a bug), conflicts may arise in the usage of the shared resources. Accordingly, for example, two or more radio protocols may operate according to specifications when operated in isolation, but may fail to operate properly in a multiradio environment.

Therefore, it may be desirable to develop a mechanism by which to manage SDR operation in a multiradio environment in a manner that may overcome at least some of the disadvantages described above.

### BRIEF SUMMARY OF EXEMPLARY EMBODIMENTS

A method, apparatus and computer program product are therefore provided that may enable management of radio operation in a multiradio environment so that a multiradio SDR may receive a measure of protection from at least some of the scenarios described above. In this regard, for example, embodiments of the present invention may provide what may be considered a “firewall” between protocol software corresponding to various particular software defined radio protocols and the radio hardware. In some embodiments, a multiradio controller may provide a time schedule, which may form a portion of instructions defining parametric limits for active radio protocols, to access hardware resources as a mechanism to prevent interference between different radio protocols. However, if a particular radio protocol is not operating properly, the particular radio protocol may not actually operate in accordance with the time schedule or instructions. Accordingly, an exemplary embodiment of the present invention may further provide a mechanism (e.g., to act as a firewall) for checking (and potentially blocking) requests for accessing radio hardware resources by each radio protocol against the instructions. Thus, for example, a checking mechanism may be provided to assist in reducing impacts related to buggy or misbehaving software.

In one exemplary embodiment, a method of providing management of radio operation in a multiradio environment is provided. The method may include receiving a communication in accordance with a protocol associated with a particular radio access technology in which the communication is associated with accessing a hardware resource for radio communication, determining whether the received communication complies with instructions defining parameters associated with providing shared access to hardware resources among a plurality of protocols associated with respective different radio access technologies, and responding to the received communication based on a result of the determining.

In another exemplary embodiment, a computer program product for providing management of radio operation in a multiradio environment is provided. The computer program product may include at least one computer-readable storage medium having computer-readable program code portions stored therein. The computer-readable program code portions may include a first executable portion, a second executable portion and a third executable portion. The first executable portion may be for receiving a communication in accordance with a protocol associated with a particular radio access technology in which the communication is associated with accessing a hardware resource for radio communication. The second executable portion may be for determining whether the received communication complies with instructions defining parameters associated with providing shared access to hardware resources among a plurality of protocols associated with respective different radio access technologies. The third executable portion may be for responding to the received communication based on a result of the determining.

In another exemplary embodiment, an apparatus for providing management of radio operation in a multiradio environment is provided. The apparatus may include a processor that may be configured to receive a communication in accordance with a protocol associated with a particular radio access technology in which the communication is associated with accessing a hardware resource for radio communication, determine whether the received communication complies with instructions defining parameters associated with providing shared access to hardware resources among a plurality of protocols associated with respective different radio access technologies, and respond to the received communication based on a result of the determining.

In another exemplary embodiment, an apparatus for providing management of radio operation in a multiradio environment is provided. The apparatus includes means for receiving a communication in accordance with a protocol associated with a particular radio access technology in which the communication is associated with accessing a hardware resource for radio communication, means for determining whether the received communication complies with instructions defining parameters associated with providing shared access to hardware resources among a plurality of protocols associated with respective different radio access technologies, and means for responding to the received communication based on a result of the determining.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates an example of a functional framework for a SDR capable of multiradio operation according to an exemplary embodiment of the present invention;

FIG. 4 illustrates a block diagram showing an apparatus for providing management of radio operation in a multiradio environment according to an exemplary embodiment of the present invention; and

FIG. 5 is a flowchart according to an exemplary method of providing management of radio operation in a multiradio environment according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

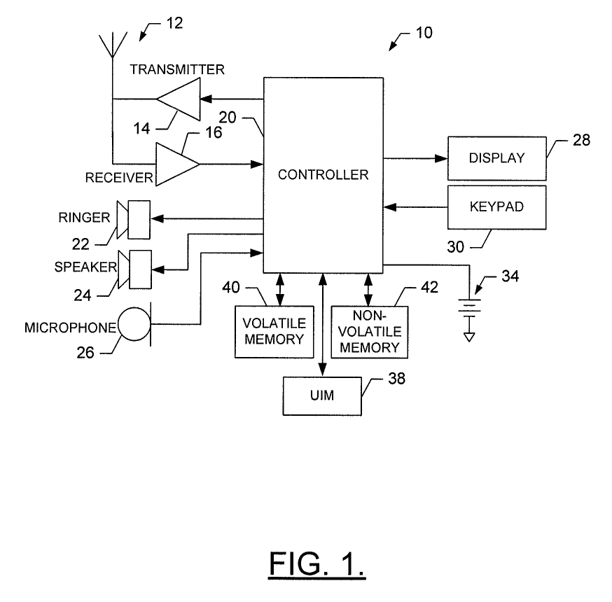

FIG. 1, one exemplary embodiment of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

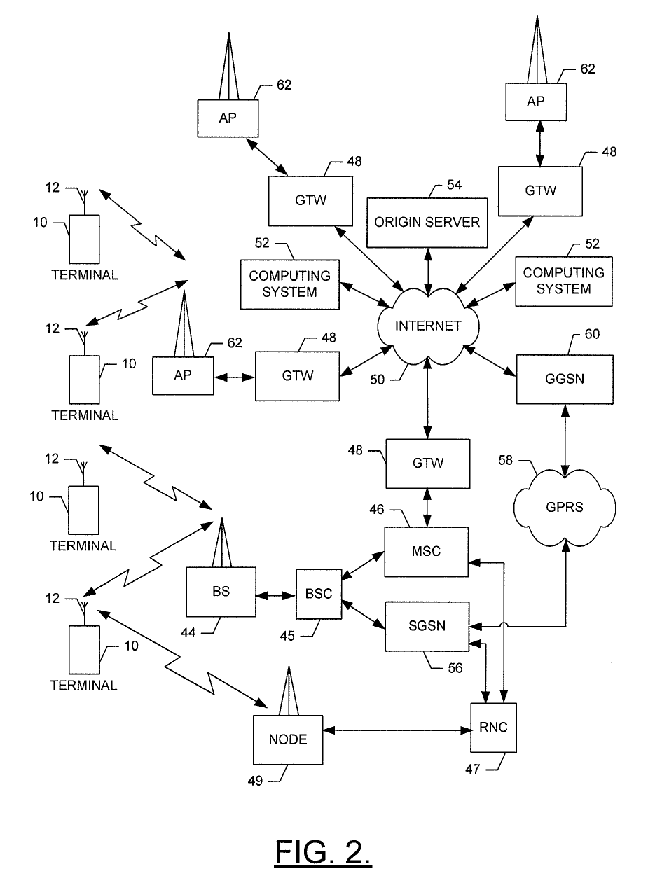

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN, with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In some embodiments, the mobile terminal 10 may be capable of receiving communication from multiple cells (e.g., multiple BSs or APs) at any given time or at different times. Furthermore, in some embodiments, the system of FIG. 2 could represent a multiple radio access technology environment. In this regard, for example, the BS 44 may be coupled to the SGSN 56 and the MSC 46 via a base station controller (BSC) 45 that may control the BS 44. The BS 44 and the BSC 45 may be associated with a first radio access technology (RAT) (e.g., a 2G RAT). Meanwhile, the SGSN 56 and the MSC 46 may also be coupled to a radio network controller (RNC) 47 of a second RAT (e.g., a 3G RAT). The RNC 47 may in turn be in communication with one or more nodes (e.g., node-Bs) 49, one or more of which may be capable of communication with the mobile terminal 10 at any given time. As such, the mobile terminal 10 may be configured to be able to communicate with (e.g., select a cell associated with) either the first RAT or the second RAT. Furthermore, additional RATs may also be included in the system of FIG. 2 so that the mobile terminal 10 may be enabled to communicate with any of a plurality of different RATs.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content or information sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a server, personal computer or other device, absent any communication with the system of FIG. 2.

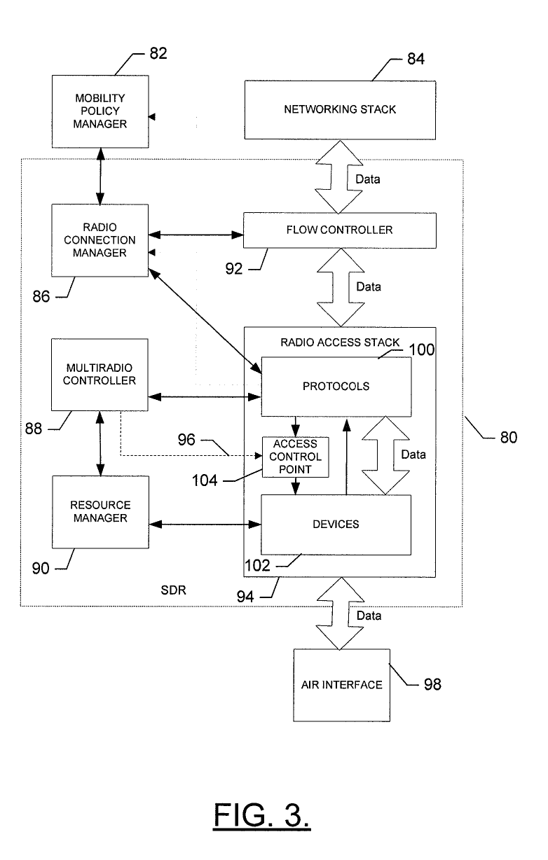

An exemplary embodiment of the present invention will now be described in connection with a software defined radio (SDR) that may be capable of operating a plurality of different protocol software applications. In this regard, each protocol may be associated with a different RAT. Thus, for example, one protocol may be associated with GSM, while another protocol may be associated with WCDMA or any of numerous other RATs. Furthermore, different or additional RATs may also be represented with additional corresponding protocols. As such, an exemplary embodiment of a SDR capable of operating as a multiradio will be described hereinafter in connection with the example shown in FIG. 3. FIG. 3 illustrates an example of a functional framework for a SDR capable of multiradio operation according to an exemplary embodiment. Accordingly, since FIG. 3 is illustrative of one example, it should be understood that other architectures including additional or even fewer elements may also be employed in connection with practicing embodiments of the present invention.

As shown in FIG. 3, an SDR 80 may be in communication with a mobility policy manager 82 and a networking stack 84. Each of the SDR 80, the mobility policy manager 82, and the networking stack 84 may be portions or modules of a communication device (e.g., the mobile terminal 10). In this regard, the networking stack 84 may be embodied as an IP stack or other communication stack for delivering data to/from the SDR 80. The mobility policy manager 82 may be any device or means embodied in hardware, software or a combination of hardware and software that is configured to activate radio services for the SDR 80 (e.g., handovers). In this regard, for example, the mobility policy manager 82 may be configured to establish data flows for the SDR 80 and/or instruct the SDR 80 to establish a call according to a particular RAT.

The SDR 80 may include a radio connection manager 86, a multiradio controller 88, a resource manager 90, a flow controller 92 and a radio access stack 94, each of which may be any means or device embodied in software, hardware or a combination of hardware and software configured to perform the corresponding functions of each device as described in greater detail below. The flow controller 92 may be in communication with the networking stack 84 and the radio access stack 94 to connect flow to a specific RAT based on control instructions from the radio connection manager 86. The radio connection manager 86 may be configured to respond to instructions from the mobility policy manager 82. In this regard, for example, the radio connection manager 86 may be configured to direct flow handovers, activate SDR radio services according to the instructions received from the mobility policy manager 82, direct the establishment of data flow as directed by the mobility policy manager 82, etc.

The resource manager 90 may be configured to track resources and assist in resource setup for each respective protocol. For example, if a call is being placed in association with a particular protocol needing a particular resource (e.g., a Bluetooth protocol attempting to transmit via a particular antenna), the resource manager 90 may facilitate the access of the needed resource by providing the protocol with a handle or identifier for accessing the resource. As such, although the resource manager 90 may be configured to at least in part facilitate access by a particular protocol to a particular resource, the resource manager 90 may typically not be involved in providing interference prevention.

The multiradio controller 88, however, may be involved in interference prevention activities. For example, the multiradio controller 88 may be configured to invoke spectral interference prevention measures by attempting to schedule times during which various protocols may access hardware or device resources with respect to data communicated or to be communicated via an air interface 98. As such, the multiradio controller 88 may be configured to generate (in some instances in response to negotiation with a particular protocol of the radio access stack 94) instructions that may include a schedule for operating protocols with regard to timing, bandwidth, power level, frequency or other parameters related to access to the hardware or device resources of the radio access stack 94. In other words, the multiradio controller 88 may be configured to define instructions for a protocol with regard to uniquely defining that which is possible for the protocol to do in relation to the resources available within the context of preventing spectral interference. The schedule may represent blocks of time and/or parameters limiting when and/or under what conditions a particular protocol may access certain hardware resources. As such, the schedule may account for priority rankings associated with each protocol or limitations associated with power, frequency, bandwidth, etc.

As shown in FIG. 3, the radio access stack 94 may include various protocols (e.g., protocols 100 each comprising a software application for enabling a respective radio functionality (as such, communications “from” a particular protocol may also be considered to be communications “in accordance with” the particular protocol)) corresponding to respective different RATs and various resources corresponding to hardware or devices (e.g., devices 102 such as RF front end components, mixers, filters, ADCs, antennas, etc.) capable of communicating via the air interface 98. In an exemplary embodiment, the radio access stack 94 may facilitate data flow for each corresponding protocol that is enabled (e.g., via control signals from the radio connection manager 86 and/or the multiradio controller 88) to access hardware resources for communication purposes. As such, according to embodiments of the present invention, the left side of FIG. 3 may relate to a control side generating and/or communicating control signals related to SDR 80 operations. Meanwhile, the right side of FIG. 3 may relate to data flow as controlled responsive to the control signals generated at the left side. Accordingly, in an exemplary embodiment as shown in FIG. 3, control may be separated from data flow to some degree.

According to an exemplary embodiment, an access control point 104 may be inserted between the protocols 100 and the devices 102 of the radio access stack 94 in order to serve in a capacity similar to a firewall. The access control point 104 may be any means or device embodied in software, hardware or a combination of hardware and software that is configured to perform the corresponding functions of the access control point 104 as described in greater detail below. In this regard, for example, the access control point 104 may be configured to provide a checking mechanism to determine whether instructions (e.g., instructions 96) or the schedule provided by the multiradio controller 88 is being properly followed by the protocols. For example, if a particular protocol passes initial operational testing in a non-multiradio environment, but fails to operate properly in a multiradio environment (e.g., due to a bug, virus infested or cracked malicious software, a particular radio application attempting to show better performance than other SDR applications, or a particular radio application attempting to move radio traffic to a network more costly to the user), the access control point 104 may provide a mechanism by which to detect the deficient behavior of the particular protocol. The access control point 104 may thereafter block a control message associated with the particular protocol (e.g., a badly behaving protocol) if the control message does not correspond with the instructions or the schedule provided by the multiradio controller 88.

Thus, according to an exemplary embodiment, if one of the protocols 100 receives control signals from the radio connection manager 86 and/or the multiradio controller 88 and, in response to the control signals (or even in response to improper operation) issues a command or request for radio resources to the devices 102, the request or command may be communicated to the devices 102 via the access control point 104. The access control point 104, which may be in communication with the multiradio controller 88 to receive information associated with the instructions and/or schedule provided to the protocols 100, may check the requests or commands directed from the protocols 100 to the devices 102 with respect to compliance with the schedule or instructions. If a particular request or command is compliant with the schedule or instructions, the request or command may be passed along to the devices 102. However, if the particular request or command is not compliant with the schedule or instructions, the request or command may be blocked by the access control point 104. In situations in which a request or command is blocked, the access control point 104 may additionally inform higher level control layers. For example, the access control point 104 may inform the mobility policy manager 82 and/or the radio connection manager 86 of a blocked command or request. Accordingly, for example, a higher level control layer may subsequently shut down the offending protocol (e.g., if a threshold number of blocks occur in aggregate or in a given time period) or even request a bug fix or inform the user of the behavior of the offending protocol.

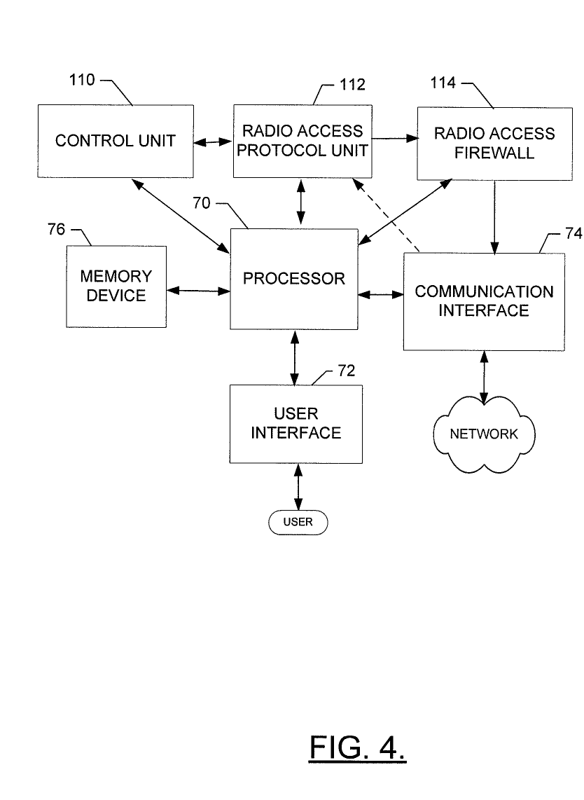

An exemplary embodiment of the invention will now be described with reference to FIG. 4, in which certain elements of an apparatus for enabling management of radio operation in a multiradio environment are displayed. The apparatus of FIG. 4 may be embodied as or otherwise employed, for example, on the mobile terminal 10. However, it should be noted that the apparatus of FIG. 4, may also be employed on a variety of other devices, both mobile and fixed, and therefore, embodiments of the present invention should not necessarily be limited to application on devices such as mobile terminals. It should also be noted that while FIG. 4 illustrates one example of a configuration of an apparatus for enabling management of radio operation in a multiradio environment, numerous other configurations may also be used to implement embodiments of the present invention.

Referring now to FIG. 4, an apparatus for enabling management of radio operation in a multiradio environment is provided. The apparatus may include or otherwise be in communication with a processor 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions corresponding to an application for execution by the processor 70. As yet another alternative, the memory device 76 may be one of a plurality of databases that store information in the form of static and/or dynamic information.

The processor 70 may be embodied in a number of different ways. For example, the processor 70 may be embodied as a processing element, a coprocessor, a controller or various other processing means or devices including integrated circuits such as, for example, an ASIC (application specific integrated circuit) or FPGA (field programmable gate array). In an exemplary embodiment, the processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna (or antennas) and supporting hardware and/or software for enabling communications with a wireless communication network. As such, the communication interface 74 may include, among other things, certain portions of the devices 102 of FIG. 3.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a trackball, a touch screen display, a conventional display, a microphone, a speaker, or other input/output mechanisms. In an exemplary embodiment in which the apparatus is embodied as a server, the user interface 72 may be limited, or even eliminated.

In an exemplary embodiment, the apparatus may also include a control unit 110, a radio access protocol unit 112 and a radio access firewall 114, each of which may be any device or means embodied in software, hardware or a combination of hardware and software. In one embodiment, the processor 70 may be embodied as or otherwise control the control unit 110 including modules or devices for performing various control functions associated with a SDR. For example, the control unit 110 may include the radio connection manager 86, the multiradio controller 88 and/or the resource manager 90 of FIG. 3. The processor 70 may also be embodied as or otherwise control the radio access protocol unit 112, which may include, for example, the flow controller 92 and/or portions of the radio access stack 94 (e.g., the protocols 100). As such, the control unit 110 may be configured to, among other things, provide instructions to the radio access protocol unit 112 to govern access afforded to the access protocol unit 112 with respect to hardware resources.

In an exemplary embodiment, the processor 70 may further be embodied as or otherwise control the radio access firewall 114. The radio access firewall 114 may include or be embodied as the access control point 104. As such, the radio access firewall 114 may be configured to check communications between the radio access protocol unit 112 and the communication interface 74 for compliance with a schedule or instructions governing access granted to the radio access protocol unit 112 with regard to hardware resources of the communication interface 74. Such communication may pass from the communication interface 74 to the radio access protocol unit 112 via the radio access firewall 114 directly, or via the processor 70 (e.g., when the processor 70 is embodied as the radio access firewall). Accordingly, in an exemplary embodiment, the radio access firewall 114 (e.g., via the access control point 104) may be configured to intercept messages intended for the hardware resources of the SDR 80 in order to ensure that such messages are compliant with instructions provided by the control unit 110.

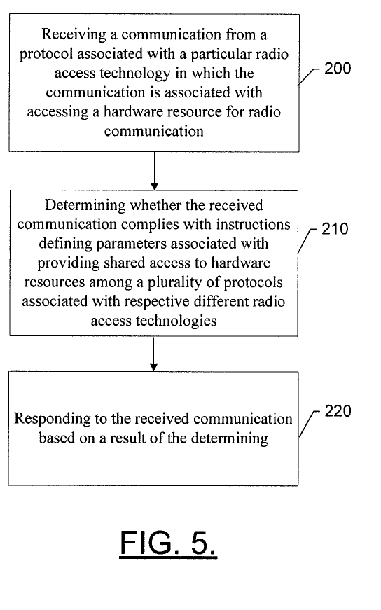

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing management of software defined radio operation in a multiradio environment as provided in FIG. 5 may include receiving a communication from a protocol associated with a particular radio access technology in which the communication is associated with accessing a hardware resource for radio communication at operation 200. At operation 210, the method may further include determining whether the received communication complies with instructions defining parameters associated with providing shared access to hardware resources among a plurality of protocols associated with respective different radio access technologies. The received communication may then be responded to based on a result of the determining at operation 220.

In an exemplary embodiment, receiving the communication may include intercepting the communication in transit between the protocol and the hardware resource. In some instances, determining whether the received communication complies with the instructions may include comparing communication parameters defined in the received communication with the instructions. In this regard, comparing communication parameters defined in the received communication with the instructions may further include comparing the communication parameters with the instructions in which the instructions are duplicative of a timing schedule provided to the protocol.

In an exemplary embodiment, responding to the received communication based on the result of the determining may include communicating the received communication to the hardware resource in response to the received communication complying with the instructions or blocking the received communication from the hardware resource in response to the received communication failing to comply with the instructions. Furthermore, if the received communication fails to comply with the instructions, responding to the received communication based on the result of the determining may include informing a higher level entity (e.g., the mobility policy manager 82 or the radio connection manager 86) of the failure of the received communication to comply with the instructions.

In an exemplary embodiment, an apparatus for performing the method above may include a processor (e.g., the processor 70) configured to perform each of the operations (200-220) described above. The processor may, for example, be configured to perform the operations by executing stored instructions for performing each of the operations. Alternatively, the apparatus may include means for performing each of the operations described above. In this regard, according to an exemplary embodiment, examples of means for performing operations 200 to 220 may include the radio access firewall 114, the access control point 104, or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-22. (canceled)

23. A method comprising:
receiving a communication in accordance with a protocol associated with a particular radio access technology in which the communication is associated with accessing a hardware resource for radio communication;
determining whether the received communication complies with instructions defining parameters associated with providing shared access to hardware resources among a plurality of protocols associated with respective different radio access technologies; and
responding to the received communication based on a result of the determining.

24. The method of claim 23, wherein receiving the communication comprises intercepting the communication directed to the hardware resource.

25. The method of claim 23, wherein determining whether the received communication complies with the instructions comprises comparing communication parameters defined in the received communication with the instructions.

26. The method of claim 25, wherein comparing communication parameters defined in the received communication with the instructions comprises comparing the communication parameters with the instructions in which the instructions are duplicative of a timing schedule provided to the protocol.

27. The method of claim 23, wherein responding to the received communication based on the result of the determining comprises communicating the received communication to the hardware resource in response to the received communication complying with the instructions.

28. The method of claim 23, wherein responding to the received communication based on the result of the determining comprises blocking the received communication from the hardware resource in response to the received communication failing to comply with the instructions.

29. The method of claim 28, wherein responding to the received communication based on the result of the determining further comprises informing a higher level entity of the failure of the received communication to comply with the instructions.

30. A computer program product comprising at least one computer-readable storage medium having computer-readable program code portions stored therein, the computer-readable program code portions comprising:
a first executable portion for receiving a communication in accordance with a protocol associated with a particular radio access technology in which the communication is associated with accessing a hardware resource for radio communication;
a second executable portion for determining whether the received communication complies with instructions defining parameters associated with providing shared access to hardware resources among a plurality of protocols associated with respective different radio access technologies; and
a third executable portion for responding to the received communication based on a result of the determining.

31. The computer program product of claim 30, wherein the first executable portion includes instructions for intercepting the communication directed to the hardware resource.

32. The computer program product of claim 30, wherein the second executable portion includes instructions for comparing communication parameters defined in the received communication with the instructions.

33. The computer program product of claim 32, wherein the second executable portion includes instructions for comparing communication parameters defined in the received communication with the instructions by comparing the communication parameters with the instructions in which the instructions are duplicative of a timing schedule provided to the protocol.

34. The computer program product of claim 30, wherein the third executable portion includes instructions for communicating the received communication to the hardware resource in response to the received communication complying with the instructions.

35. The computer program product of claim 30, wherein the third executable portion includes instructions for blocking the received communication from the hardware resource in response to the received communication failing to comply with the instructions.

36. The computer program product of claim 35, wherein the third executable portion includes instructions for informing a higher level entity of the failure of the received communication to comply with the instructions.

37. An apparatus, comprising:
at least one processor; and
at least one memory including computer program code,
the at least one memory and the computer program code configured to, with the at least one processor, cause the apparatus to perform at least the following:
receive a communication in accordance with a protocol associated with a particular radio access technology in which the communication is associated with accessing a hardware resource for radio communication;
determine whether the received communication complies with instructions defining parameters associated with providing shared access to hardware resources among a plurality of protocols associated with respective different radio access technologies; and
respond to the received communication based on a result of the determining.

38. The apparatus of claim 37, wherein receive a communication comprises intercepting the communication directed to the hardware resource.

39. The apparatus of claim 37, wherein determine whether the received communication complies with the instructions comprises comparing communication parameters defined in the received communication with the instructions.

40. The apparatus of claim 39, wherein compare communication parameters defined in the received communication with the instructions further comprises comparing the communication parameters with the instructions in which the instructions are duplicative of a timing schedule provided to the protocol.

41. The apparatus of claim 37, wherein respond to the received communication based on the result of the determining comprises communicating the received communication to the hardware resource in response to the received communication complying with the instructions.

42. The apparatus of claim 37, wherein respond to the received communication based on the result of the determining comprises blocking the received communication from the hardware resource in response to the received communication failing to comply with the instructions.
